(19) United States
(12) Patent Application Publication
(10) Pub. No.: US 2026/0249985 A1
(43) Pub. Date: Aug. 27, 2026

(54) BRAKE SYSTEM

(71) Applicant: Tusas- Turk Havacilik Ve Uzay Sanayii Anonim Sirketi, Ankara (TR)

(72) Inventors: Burak AKGUN, Ankara (TR); Tugrul YILDIRIM, Ankara (TR); Merve DEMIROGLU, Ankara (TR); Halil CEYHAN, Ankara (TR)

(73) Assignee: Tusas- Turk Havacilik Ve Uzay Sanayii Anonim Sirketi, Ankara (TR)

(21) Appl. No.: 18/725,785

(22) PCT Filed: Nov. 15, 2022
(86) PCT No.: PCT/TR2022/051292

§ 371 Date: Jun. 30, 2024

(30) Foreign Application Priority Data
Dec. 30, 2021 (TR) 2021/021743

(51) Int. Cl. B64C 25/44; B64C 25/34; B64U 10/25

(52) U.S. Cl. CPC B64C 25/44; B64C 25/34; B64U 10/25

(57) ABSTRACT

The present invention relates to an air vehicle (V); a plurality of wheels (2) located on the air vehicle (V) and enabling movement of the air vehicle (V) on the ground (Z); at least one rotating structure (3) located on the air vehicle (V) to be concentric with the wheel (2) and performing rotational movement with the wheel (2); a friction element (4) which contacts and suppresses the rotating structure (3), thereby creating a braking force and enabling the air vehicle (V) to be decelerated; at least one actuator (5) triggered by an electric motor (E) such that pressure of the hydraulic fluid (H) therein changes, thus enabling the friction element (4) to be moved towards or away from the rotating structure (3); a chamber (6) in which the hydraulic fluid (H) required for the operation of the actuator (5) is stored; a control unit (7) which controls movement of the actuator (5) and pressure of the hydraulic fluid (H) based on the command transmitted from the user and/or flight control software, and adjusts the amount of braking force applied to the air vehicle (V).

The present invention relates to a hydraulic brake system in air and/or space vehicles.

Brake systems in air and/or space vehicles are basic systems that allow control of the velocity and maneuvering of the air vehicle during its movement on the runway. In the known-state of the art, hydraulic brakes are generally used in air vehicles, and the braking force is transferred to the hydraulic brake calipers on the wheel by means of master cylinders. Brake systems in manned air vehicles are used under pilot control. In this case, the braking force required is produced by the pilot applying force and pressing the master cylinder, while in unmanned air vehicles, this effect is realized by an electric motor.

In floating disc type hydraulic brake systems, the problem of increasing the distance between the caliper pistons and the lining as a result of the tilting movement of the brake disc is solved by applying more braking force by the pilot. In order to achieve a similar effect in unmanned air vehicles, a control unit that sends commands to a pressure sensor and an actuator is used. Further, studies are carried out on various systems that adjust the amount of hydraulic fluid in the brake system.

Chinese patent document CN108146621, which is included in the known-state of the art, discloses a brake control technology used in unmanned air vehicles and a system based on a hydraulic transmission triggered by an electric motor. Said application discloses that the pressure generated by the compression of the hydraulic oil by the piston is converted into a braking force.

A brake system according to the present invention enables the deceleration and stopping processes for the air vehicle to be performed more practically and reliably.

Another object of the present invention is to perform the deceleration process of the vehicle by a more efficient system in hydraulic brake systems triggered by an electric motor in air and/or space vehicles.

Another object of the present invention is to provide a brake system that performs the control of brake systems in unmanned air vehicles in a safer and faster manner.

The brake system realized to achieve the object of the invention, which is defined in the first claim and other claims dependent thereon, comprises an air vehicle which is an aircraft and/or unmanned aerial vehicle; a plurality of wheels located on the air vehicle in connection with the air vehicle, controlled by a pilot or capable of operating autonomously, and provided at a location where the air vehicle contacts the ground, e.g. the runway, thereby allowing the air vehicle to move and change direction on the ground; a rotating disk-shaped structure substantially in the same form as the wheel, which is located on the air vehicle so as to be in connection and aligned with the wheel, and is rotatable concurrently with the wheel; a friction element located on the brake system in contact with the rotating structure on both sides of the rotating structure, compressing the rotating structure and applying a pressure force to prevent the rotating structure from rotating, thus creating a braking force in the air vehicle and reducing the air vehicle speed. The actuator provides actuation of the friction element so as to increase or decrease a distance between the friction element and the rotating structure by transferring the movement transmitted by the electric motor. There is a chamber for storing a hydraulic fluid used by the actuator, wherein the hydraulic fluid is pressurized such that the friction element contacts the rotating structure and the friction element is moved away from the rotating structure by cutting the contact thereof. With the increase in hydraulic pressure in the actuator triggered by the electric motor, the braking force increases, and when the pressure decreases, the braking force applied to the air vehicle decreases.

The brake system according to the invention comprises a piston that performs a linear movement in the actuator, thus allowing and/or preventing hydraulic fluid passage from the actuator to the chamber or from the chamber to the actuator. The piston causes the pressure to increase by compressing the hydraulic fluid, thus braking force is applied to the air vehicle. The piston has an opened position (O) in which the hydraulic fluid is allowed to pass from the chamber to the actuator and/or from the actuator to the chamber, and a closed position (C) in which the piston closes the chamber port so as to prevent hydraulic fluid passage between the chamber and the actuator, wherein the piston is brought from the opened position (O) to the closed position (C) by sliding. When a command issued by the user and/or control unit to apply a braking force to the air vehicle ends, the control unit brings the piston into the opened position (O) and keeps it in that position for a predetermined time that is input into the control unit to balance the amount of hydraulic fluid in the actuator, and then the control unit brings the piston into the closed position (C), such that the hydraulic fluid hits the friction element of the disc and does not passes into the chamber prior to the next braking command.

In an embodiment of the invention, the brake system comprises a shaft which connects the wheel and rotating structure at their center and allows them to be removably mounted on the air vehicle; and a plurality of lugs on the friction element, which contact the rotating structure on the sides forming its thickness so as to a apply pressure force thereon, thus applying braking force to the air vehicle; a braking position in which the lugs decelerate the air vehicle by compressing the rotating structure from different parts; and a free position in which the lugs and the rotary structure are not in contact with each other and do not apply braking force to the air vehicle.

In an embodiment of the invention, the brake system comprises the floating disc type rotating structure, wherein if the piston remains in the opened position (O) while the lugs are in the free position (R) when the air vehicle taxis on the ground, the floating disc type rotating structure causes hydraulic fluid to pass from the actuator to the chamber as a result of the rotating disc hitting the lugs; and the piston which is brought to the closed position (C) to prevent hydraulic fluid passage to the chamber, in order to keep the amount of hydraulic fluid in the actuator constant.

In an embodiment of the invention, the brake system comprises a channel located on the actuator and containing the hydraulic fluid, wherein the piston is placed in the channel such that it moves linearly and there is no space between the piston and an inner wall of the channel. Thanks to the channel, the hydraulic fluid is activated by the piston, and the channel and transmission elements can be compressed within its volume. There is a neck which is in a transition zone between the chamber and the actuator, thus enabling the chamber to exchange hydraulic fluid with the channel; and the piston opposite the neck to close the chamber port, which restricts the hydraulic fluid movement.

In an embodiment of the invention, the brake system comprises a pressure sensor with connections for detecting the hydraulic fluid pressure and transferring the measured data to the control unit. The control unit compares a value received from the pressure sensor with a threshold value predetermined by the manufacturer. If the value measured by the pressure sensor differs from the threshold value, the piston is moved to the opened position (O) or the closed position (C) by the control unit, so that the amount of hydraulic fluid in the actuator is brought to the values in the operating range of the brake system. Thus, a predetermined braking force is applied to the air vehicle despite a braking force input given by the user and/or control unit.

In an embodiment of the invention, the brake system comprises the control unit, wherein if the value measured by the pressure sensor for the hydraulic fluid pressure in the actuator is lower than the threshold value pre-stored in the control unit, the control unit repeatedly moves the piston between the opened (O) and closed (C) positions for a plurality of times, enabling the hydraulic fluid to be pumped from the chamber to the actuator, so that a desired braking force is applied to the air vehicle when the amount of hydraulic fluid in the actuator is subjected to predetermined compression.

In an embodiment of the invention, the brake system comprises braking levels obtained by the braking force acting on wheels and by actuating the piston for providing the corresponding braking force, wherein the braking levels must be measured as a predetermined value by the sensor. If a sufficient amount of hydraulic fluid is present in the actuator, a rotation angle value for the electric motor is determined, which corresponds the value at which the required pressure is provided for each braking level. In case the rotation angle value for the electric motor is above the threshold value predetermined by the manufacturer, the control unit brings the piston to the opened position (O) to transfer the hydraulic fluid from the actuator to the chamber, thus adjusting the amount of hydraulic fluid in the actuator. Braking levels refer to situations where the friction element and the rotating structure contact each other and the braking force applied to the air vehicle by the brake system is non-zero.

In an embodiment of the invention, the brake system comprises the control unit which compares the rotation angle value for the electric motor corresponding to each braking level with the threshold value predetermined by the manufacturer, and brings the piston to the opened position (O) to allow hydraulic fluid passage from the chamber to the actuator when the rotation angle value for the electric motor is below the threshold value, so that the amount of hydraulic fluid in the actuator is adjusted and the desired pressure is obtained when the braking command is issued.

In an embodiment of the invention, the brake system comprises the control unit which allows a command to be transmitted to the actuator to remain inactive in order to keep the pressure constant, if the hydraulic fluid pressure value required for the related braking level is obtained as a level predetermined by the manufacturer as a result of the movement of the piston based on the command received by the user and/or the control unit.

In an embodiment of the invention, the brake system comprises the spring connected to the piston so as to be activated by the energy storage element, which is compressed or loosened by the actuation of the electric motor to allow the piston to change its position; the piston which enables the piston to be in the opened position (O) when the spring is uncompressed, and enables the piston to move linearly in the channel when energy is stored by the spring. The piston causes pressure increase by compressing the hydraulic fluid, and the braking force is applied to the wheels by transferring this pressure.

In an embodiment of the invention, the brake system provides pressure increase by compressing the hydraulic fluid in the actuator by the piston. It comprises a piston having a remote position (U) which represents a maximum hydraulic fluid pressure and a maximum braking force applied to the air vehicle.

In an embodiment of the invention, the brake system comprises the control unit which compares a value received instantaneously from the pressure sensor with the hydraulic fluid pressure value predetermined by the manufacturer and stored in the control system for the braking level corresponding to the command issued by the user and/or flight control software, wherein if the value received from the pressure sensor is below the pressure value that should be provided for the braking level, the control unit moves the piston towards the remote position (U) such that the piston compresses the hydraulic fluid and increases its pressure, thereby obtaining the desired braking force.

In an embodiment of the invention, the brake system comprises the control unit having an autonomous mode in which air vehicle control commands are transmitted by the control unit, and a manual mode which allows the air vehicle to be controlled manually by the pilot or the user.

The brake system realized to achieve the object of the present invention is illustrated in the attached drawings, in which:

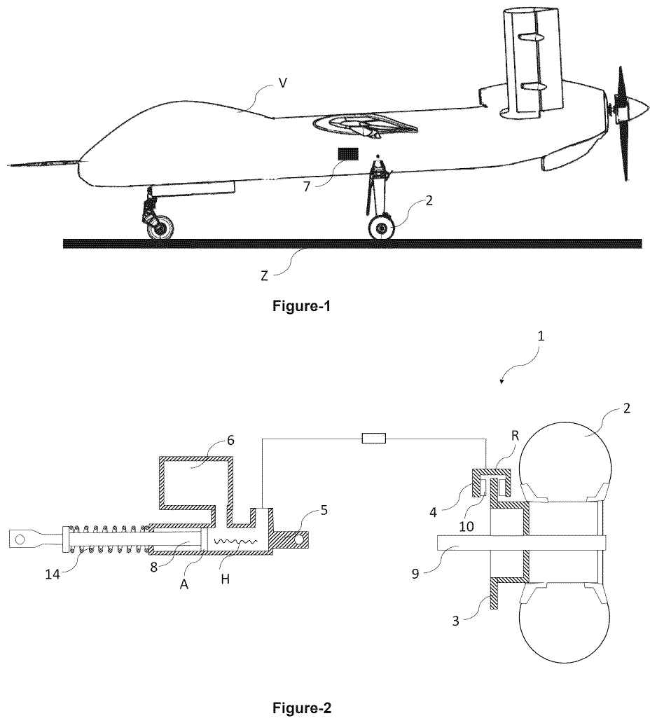

FIG. 1 is a schematic view of an air vehicle and a braking system.

FIG. 2 is a side sectional view of a braking system with the piston in the opened position (O).

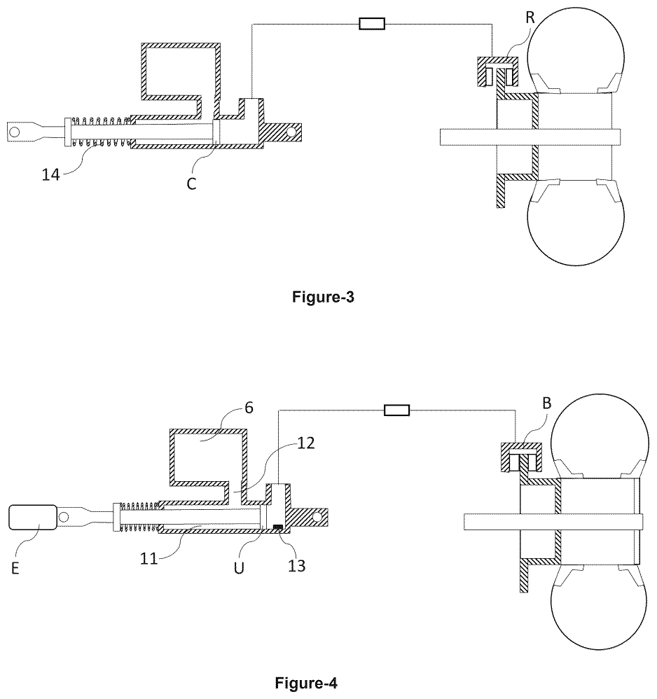

FIG. 3 is a side sectional view of a braking system with the piston in the closed position (C).

FIG. 4 is a top sectional view of a braking system with the piston in the remote position (U).

FIG. 5 is a graphical view of the braking levels that represents change levels of the braking force applied to the air vehicle and the hydraulic fluid pressure value over time.

All the parts illustrated in figures are individually assigned a reference numeral and the corresponding terms of these numbers are listed below:
1. Brake system
2. Wheel
3. Rotating structure
4. Friction element
5. Actuator
6. Chamber
7. Control unit
8. Piston
9. Shaft
10. Lug
11. Channel
12. Neck
13. Pressure sensor
14. Spring
(V) Air vehicle
(E) Electric motor
(H) Hydraulic fluid
(O) Opened position
(C) Closed position
(B) Braking position
(R) Free position
(Z) Ground
(U) Remote position

The brake system (1) comprises an air vehicle (V); a plurality of wheels (2) located on the air vehicle (V) and enabling movement of the air vehicle (V) on the ground (Z); at least one rotating structure (3) located on the air vehicle (V) to be concentric with the wheel (2) and performing rotational movement with the wheel (2); a friction element (4) which contacts and suppresses the rotating structure (3), thereby creating a braking force and enabling the air vehicle (V) to be decelerated; at least one actuator (5) triggered by an electric motor (E) such that pressure of the hydraulic fluid (H) therein changes, thus enabling the friction element (4) to be moved towards or away from the rotating structure (3); a chamber (6) in which the hydraulic fluid (H) required for the operation of the actuator (5) is stored; a control unit (7) which controls movement of the actuator (5) and pressure of the hydraulic fluid (H) based on the command transmitted from the user and/or flight control software, and adjusts the amount of braking force applied to the air vehicle (V) (FIG. 1).

The brake system (1) according to the invention comprises a piston (8) located to control hydraulic fluid (H) passage between the actuator (5) and the chamber (6) by acting on the actuator (5); an opened position (O) in which the piston (8) allows hydraulic fluid (H) passage between the chamber (6) and the actuator (5); a closed position (C) in which the piston (8) is positioned to prevent hydraulic fluid (H) passage between the chamber (6) and the actuator (5), wherein the piston (8) is moved to be brought from the opened position (O) to the closed position (C); the control unit (7) which enables the piston (8) to be brought to the opened position (O) and kept there for a time predetermined by the manufacturer in order to adjust the amount of hydraulic fluid (H) when the braking force applied to the air vehicle (V) is stopped, and enables the piston (8) to be brought to the closed position (C) such that the hydraulic fluid (H) remains substantially in the actuator (5) prior to the next braking command (FIG. 2).

The air vehicle (V) carries out its movement on the ground (Z) by means of the wheels (2), and a floating disc type hydraulic brake system (1) is used to decelerate and/or stop the air vehicle (V). The rotating structure (3) is mounted removably, by means of fasteners, on the air vehicle (V) in a recess which is shape-compatible with the rotating structure (3) and is located in the wheels (2). The friction element (4) is located on the brake system (1) so as to be opposite to the surfaces forming the thickness of the rotating structure (3), and due its contact to these surfaces, it can compress the rotating structure (3) by pressing. The braking process is performed by keeping one side of the friction element (4) fixed, and bringing the other side thereof closer to the rotating structure (3) or by bringing both sides closer to the rotating structure (3). Actuation of the friction element (4) is provided by an electric motor (E), e.g. a servo motor, a piston-cylinder type actuator (5) operating with hydraulic oil, and transmission systems located therebetween. Magnitude of the braking force to be applied to the air vehicle (V) is divided into sections, called braking levels, which have a predetermined force value, wherein the process of determining the braking level corresponding to the input given by the user and/or the control unit (7) is performed by the control unit (7). The control unit (14) provides the processes of: triggering the electric motor (E) to bring each braking level to the required angle value, pressurizing the hydraulic fluid by means of the piston, and drawing sufficient amount of current (FIG. 3).

In order to perform the braking process, the rotating structure (3) and the friction element (4) must be in contact with each other. The pressure force to be applied to the rotating structure (3) by the friction element (4) increases or decreases in direct proportion to the hydraulic fluid (H) pressure inside the actuator (5). There must be a predetermined amount of hydraulic fluid (H) in the actuator (5) in order to provide the pressure required to obtain the braking force. The hydraulic fluid (H) is stored in the chamber (6) and the fluid passage between the chamber (6) and the actuator (5) is controlled by means of a piston (8) located to close the port of the chamber (6). While the air vehicle (V) is moving on the ground (Z), the rotating structure (3) being the brake disc contacts the friction element (4) as a result of the tilting movement it will perform. If the piston (8) is in the opened position (O), some of the hydraulic fluid (H) can move towards the chamber (6) from the actuator (5) and leak into the chamber (6) due to the force effect resulting from this contact. The piston (8) is kept in the closed position (C) in order to prevent the hydraulic fluid (H) from escaping into the chamber (6). The piston (8) is in the closed position (C) while braking force is applied to the air vehicle (V). When the braking command issued by the user and/or control unit (7) ends, the piston (8) is first brought to the opened position (O) in order to balance the amount of hydraulic fluid (H) in the actuator (5), and kept in the opened position (O) for a while in order to balance the amount of hydraulic fluid (H), after which it is brought to the closed position (C) and kept in the closed position (C) until a new brake command is received (FIG. 4).

In an embodiment of the invention, a brake system (1) comprises a shaft (9) passing through the center of the wheel (2) and the rotating structure (3) so as to mount them concentrically on the air vehicle (V); and a plurality of lugs (10) located on the friction element (4), which contact and suppress the rotating structure (3) on both sides, thus enabling the braking force to be applied to the air vehicle (V); a braking position (B) in which the lugs (10) contact the rotating structure (3) so that the braking force is applied to the air vehicle (V); and a free position (R) in which the lugs (10) and the rotary structure (3) are not in contact with each other. By means of the shaft (9), the rotating structure (3) is placed between the lugs (10) of the friction element (4) so as to allow rotational movement. Thus, the braking force is applied by pressing the rotating structure (3) by the lugs (10) on both sides thereof.

In an embodiment of the invention, a brake system (1) comprises a floating disc type rotating structure (3) which, during the maneuvering motion of the air vehicle (V) on the ground (Z), hits the lugs (10) in the free position (R), thus causing the hydraulic fluid (H) to escape from the actuator (5) into the chamber (6); and the piston (8) which is brought to the closed position (C) to prevent the hydraulic fluid (H) passage into the chamber (6). Thus, while the air vehicle (V) maneuvers, the rotating structure (3) hits the lugs (10) and the hydraulic fluid (H) is prevented from escaping into the chamber (6). In this way, a predetermined amount of hydraulic fluid (H) remains in the actuator (5), and the desired braking force can be obtained after the brake command issued by the user and/or the control unit (7).

In an embodiment of the invention, a brake system (1) comprises a channel (11) on the actuator (5), in which the piston (8) makes a linear movement to move the hydraulic fluid (H); a neck (12) on the chamber (6), which enables the chamber (6) to exchange hydraulic fluid (H) with the channel (11); the piston (8) located in the channel (11) so as to be opposite the neck (12). The piston (8) moves in the channel (11) such that the neck (12) inlet is opened to allow passage of fluid and closed to prevent the passage of fluid. Therefore, the piston (8) controls the hydraulic fluid (H) passage between the actuator (5) and the chamber (6).

In an embodiment of the invention, a brake system (1) comprises a pressure sensor (13) that enables pressure of the hydraulic fluid (H) to be measured and transferred to the control unit (7); and the control unit (7) which, if a value received from the pressure sensor (13) differs from a threshold value predetermined by the manufacturer, actuates the piston (8) to bring the amount of hydraulic fluid (H) in the actuator (5) to the value predetermined by the manufacturer, thereby enabling predetermined braking forces to be applied to the wheels (2). By activating the piston (8) by the control unit (7), the amount of hydraulic fluid (H) in the actuator (5) is adjusted to keep it at a level with which predetermined pressure values can be achieved. Thus, the pressure value required for the braking level corresponding to the issued braking command can be obtained.

In an embodiment of the invention, a brake system (1) comprises the control unit (7) which moves the piston (8) repeatedly between the opened position (O) and the closed position (C) if pressure of the hydraulic fluid (H) inside the actuator (5) is lower than the value predetermined by the manufacturer, thereby enabling transfer of hydraulic fluid (H) from the chamber (6) into the actuator (5). In case the desired hydraulic fluid (H) pressure cannot be obtained despite a certain input by the electric motor (E), it is decided by the control unit (7) that the hydraulic fluid (H) amount in the actuator (5) is low. The piston (8) moved between the opened position (O) and the closed position (C) for a plurality of times acts as a pump and enables the hydraulic fluid (H) in the chamber (6) to be transferred into the actuator (5).

In an embodiment of the invention, a brake system (1) comprises a plurality of braking levels, in which the braking force applied to the wheels (2) and the pressure value of hydraulic fluid (H) are kept constant at a level predetermined by the manufacturer; the control unit (7) which, when the rotation angle value of the electric motor (E) corresponding to each braking level is above the threshold value predetermined by the manufacturer, brings the piston (8) to the opened position (O) to enable hydraulic fluid (F) passage from the actuator (5) to the chamber (6), thus adjusting the amount of hydraulic fluid (H) in the actuator (5). If the hydraulic fluid (H) pressure required for the related braking level cannot be obtained even though the electric motor (E) is brought to the angle value determined for the braking level, angle value of the electric motor (E) increases and exceeds the threshold value determined for the braking level. In this case, the piston (8) is brought to the opened position (O), so that the amount of hydraulic fluid (H) is adjusted.

In an embodiment of the invention, a brake system (1) comprises the control unit (7) which, when the rotation angle value of the electric motor (E) corresponding to each braking level is below the threshold value predetermined by the manufacturer, brings the piston (8) to the position (A) to enable hydraulic fluid (H) passage from the actuator (5) into the chamber (6), thereby balancing the amount of hydraulic fluid (H) in the actuator (5). Thus, by ensuring a sufficient amount of hydraulic fluid (H) in the actuator (5), the braking force desired by the user is obtained.

In an embodiment of the invention, a brake system (1) comprises the control unit (7) which, if the pressure value of the hydraulic fluid (H) required for the related braking level is at a level predetermined by the manufacturer when the user and/or the control unit (7) issues a command, enables the actuator (5) to receive a command to be active and/or inactive such that the pressure is kept constant. The control unit (7) determines that the system is in the normal operating range when the rotation angle of the electric motor (E) and the pressure of hydraulic fluid (H) in the actuator (5) for each braking level comply with the threshold values.

In an embodiment of the invention, a brake system (1) comprises at least one spring (14) located on the actuator (5) in connection with the piston (8), wherein the spring (14) is triggered by the electric motor (E) so as to be compressed or loosened, thereby activating the piston (8); the piston (8) which enables the piston (8) to be in the opened position (O) when the spring (14) is released, and which moves linearly in the channel (11) to compress the hydraulic fluid (H) and increase its pressure, thereby enabling the braking force to be applied on the air vehicle (V). The brake force is applied to the air vehicle (V) by the piston (8) actuated by the spring (14), and the fluid connection between the chamber (6) and the actuator (5) is opened or closed.

In an embodiment of the invention, a brake system (1) comprises a remote position (U) to which the piston (8) is brought so as to increase the pressure value of the hydraulic fluid (H) in the actuator (5), thereby obtaining a maximum value of the braking force applied on the air vehicle (V). When the piston (8) is in the remote position (U), the force acting on the hydraulic fluid (H) increases and the maximum amount of compression is obtained, so the braking force and pressure value obtain the maximum value possible.

In an embodiment of the invention, a brake system (1) comprises the control unit (7) which compares a value received instantaneously from the pressure sensor (13) with the pressure value predetermined for the braking level corresponding to the command transmitted from the user and/or flight control software, wherein if the value received from the pressure sensor (13) is below the pressure value for the braking level, the control unit (7) moves the piston (8) towards the remote position (U) so as to increase pressure of the hydraulic fluid (H), thereby obtaining the desired braking force. If the required hydraulic fluid (H) pressure value cannot be achieved when the electric motor (E) is brought to an angle that is the threshold value predetermined for the related braking level, the piston (8) is moved towards the remote position (U) and braking process is performed safely.

In an embodiment of the invention, a brake system (1) comprises the control unit (7) which detects a velocity value of the air vehicle (V) on the ground (Z) when the air vehicle (V) is not braked, and if the velocity value is above the threshold value predetermined by the manufacturer, enables the piston (8) in the closed position (C) to be brought to the opened position (O) momentarily and returned to the closed position (C) after a while, thereby balancing excess pressure of the hydraulic fluid (H) in the actuator (5).

In an embodiment of the invention, a brake system (1) comprises the control unit (7) having an autonomous mode in which air vehicle (V) control commands are issued by means of the control unit (7), and a manual mode which allows the air vehicle (V) to be controlled by the pilot. In order for the air vehicle (V) to move autonomously, it is possible to switch to the autopilot via the control unit (7), and when the operator wants to give a command to the air vehicle (V), it can be switched to manual mode via the control unit (7).

1. A brake system comprising an air vehicle (V); a plurality of wheels located on the air vehicle (V) and enabling movement of the air vehicle (V) on the ground (Z); at least one rotating structure located on the air vehicle (V) to be concentric with the wheel and performing rotational movement with the wheel; a friction element which contacts and suppresses the rotating structure, thereby creating a braking force and enabling the air vehicle (V) to be decelerated; at least one actuator triggered by an electric motor (E) such that pressure of the hydraulic fluid (H) therein changes, thus enabling the friction element to be moved towards or away from the rotating structure; a chamber in which the hydraulic fluid (H) required for the operation of the actuator is stored; a control unit which controls movement of the actuator and pressure of the hydraulic fluid (H) based on the command transmitted from the user and/or flight control software, and adjusts the amount of braking force applied to the air vehicle (V), wherein a piston located to control the hydraulic fluid (H) passage between the actuator and the chamber by acting on the actuator; an opened position (O) in which the piston allows the hydraulic fluid (H) passage between the chamber and the actuator; a closed position (C) in which the piston is positioned to prevent the hydraulic fluid (H) passage between the chamber and the actuator, wherein the piston is moved to be brought from the opened position (O) to the closed position (C); the control unit which enables the piston to be brought to the opened position (O) and kept there for a time predetermined by the manufacturer in order to adjust the amount of the hydraulic fluid (H) when the braking force applied to the air vehicle is stopped, and enables the piston to be brought to the closed position (C) such that the hydraulic fluid (H) remains substantially in the actuator prior to the next braking command.

2. A brake system according to claim 1, wherein a shaft passing through the center of the wheel and the rotating structure so as to mount them concentrically on the air vehicle (V); and a plurality of lugs located on the friction element, which contact and suppress the rotating structure on both sides, thus enabling the braking force to be applied to the air vehicle (V); a braking position (B) in which the lugs contact the rotating structure so that the braking force is applied to the air vehicle (V); and a free position (R) in which the lugs and the rotary structure are not in contact with each other.

3. A brake system according to claim 2, wherein a floating disc type rotating structure which, during the maneuvering motion of the air vehicle (V) on the ground (Z), hits the lugs in the free position (R), thus causing the hydraulic fluid (H) to escape from the actuator into the chamber; and the piston which is brought to the closed position (C) to prevent the hydraulic fluid (H) passage into the chamber.

4. A brake system according to claim 1, wherein a channel on the actuator, in which the piston makes a linear movement to move the hydraulic fluid (H); a neck on the chamber, which enables the chamber to exchange the hydraulic fluid (H) with the channel; the piston located in the channel so as to be opposite the neck.

5. A brake system according to claim 1, wherein a pressure sensor that enables pressure of the hydraulic fluid (H) to be measured and transferred to the control unit; and the control unit which, if a value received from the pressure sensor differs from a threshold value predetermined by the manufacturer, actuates the piston to bring the amount of the hydraulic fluid (H) in the actuator to the value predetermined by the manufacturer, thereby enabling predetermined braking forces to be applied to the wheels.

6. A brake system according to claim 1, wherein the control unit which moves the piston repeatedly between the opened position (O) and the closed position (C) if pressure of the hydraulic fluid (H) inside the actuator is lower than the value predetermined by the manufacturer, thereby enabling transfer of the hydraulic fluid (H) from the chamber into the actuator.

7. A brake system according to claim 1, wherein a plurality of braking levels, in which the braking force applied to the wheels and the pressure value of the hydraulic fluid (H) are kept constant at a level predetermined by the manufacturer; the control unit which, when the rotation angle value of the electric motor (E) corresponding to each braking level is above the threshold value predetermined by the manufacturer, brings the piston to the opened position (O) to enable the hydraulic fluid (H) passage from the actuator to the chamber, thus adjusting the amount of the hydraulic fluid (H) in the actuator.

8. A brake system according to claim 7, wherein the control unit which, when the rotation angle value of the electric motor (E) corresponding to each braking level is below the threshold value predetermined by the manufacturer, brings the piston to the position (A) to enable hydraulic fluid (H) passage from the actuator into the chamber, thereby balancing the amount of the hydraulic fluid (H) in the actuator.

9. A brake system according to claim 7, wherein the control unit which, if the pressure value of the hydraulic fluid (H) required for the related braking level is at a level predetermined by the manufacturer when the user and/or the control unit issues a command, enables the actuator to receive a command to be active and/or inactive such that the pressure is kept constant.

10. A brake system according to claim 4, wherein at least one spring located on the actuator in connection with the piston, wherein the spring is triggered by the electric motor (E) so as to be compressed or loosened, thereby activating the piston; the piston which enables the piston to be in the opened position (O) when the spring is released, and which moves linearly in the channel to compress the hydraulic fluid (H) and increase its pressure, thereby enabling the braking force to be applied on the air vehicle (V).

11. A brake system according to claim 1, wherein remote position (U) to which the piston is brought so as to increase the pressure value of the hydraulic fluid (H) in the actuator, thereby obtaining a maximum value of the braking force applied on the air vehicle (V).

12. A brake system according to claim 7, wherein the control unit which compares a value received instantaneously from the pressure sensor with the pressure value predetermined for the braking level corresponding to the command transmitted from the user and/or flight control software, wherein if the value received from the pressure sensor is below the pressure value for the braking level, the control unit moves the piston towards the remote position (U) so as to increase pressure of the hydraulic fluid (H), thereby obtaining the desired braking force.

13. A brake system according to claim 1, wherein the control unit which detects a velocity value of the air vehicle (V) on the ground (Z) when the air vehicle (V) is not braked, and if the velocity value is above the threshold value predetermined by the manufacturer, enables the piston in the closed position (C) to be brought to the opened position (O) momentarily and returned to the closed position (C) after a while, thereby balancing excess pressure of the hydraulic fluid (H) in the actuator.

14. A brake system according to claim 1, wherein the control unit having an autonomous mode in which the air vehicle (V) control commands are issued by means of the control unit, and a manual mode which allows the air vehicle (V) to be controlled by the pilot.
